(19) United States
(12) Patent Application Publication
(10) Pub. No.: US 2025/0023426 A1
(43) Pub. Date: Jan. 16, 2025

(54) E-MACHINE SYSTEM WITH WINDINGS ARRANGEMENT HAVING COOLING PASSAGES

(71) Applicant: Garrett Transportation I Inc., Torrance, CA (US)

(72) Inventors: Filip Tomanec, Nivnice (CZ); David Slama, Brno (CZ); Jakub Kadrnka, Brno (CZ); Petr Chmelicek, Brno (CZ); Tsu-Ang Yang, Brno (CZ); Petr Kachlik, Telnice (CZ)

(73) Assignee: Garrett Transportation I Inc., Torrance, CA (US)

(21) Appl. No.: 18/350,834

(22) Filed: Jul. 12, 2023

(51) Int. Cl. H02K 9/19; H02K 1/16; H02K 5/04; H02K 15/06

(52) U.S. Cl. CPC H02K 9/19; H02K 1/16; H02K 5/04; H02K 15/06

(57) ABSTRACT

An e-machine includes a stator core having a first axial end and a second axial end that are separated along a longitudinal axis. The stator core has a slot that extends between the first axial end and the second axial end. The e-machine further includes a plurality of winding members. The plurality of winding members comprise a plurality of longitudinal segments that are received in the slot and that extend between the first axial end and the second axial end. Individual ones of the plurality of longitudinal segments have a cross-sectional profile that is non-circular. The plurality of longitudinal segments are disposed in an abutting arrangement to define a fluid passageway within the slot and between neighboring ones of the plurality of longitudinal segments. The fluid passageway extends between the first axial end and the second axial end of the stator core.

### TECHNICAL FIELD

The present disclosure relates, generally, to an e-machine and, more particularly, to an e-machine system with a windings arrangement having cooling passages.

### BACKGROUND

E-machines, such as electric motors, electric generators, and combination motor/generators, are provided for a variety of uses. For example, electric traction motors are proposed for electric vehicles, locomotives, and the like.

Some e-machine systems may generate heat during operation, may operate in high-temperature environments, etc. Elevated temperatures may hinder performance and/or cause other disadvantages. Thus, e-machine systems are proposed that include cooling features. However, providing such cooling features remains challenging. There may be detrimental increases in costs, part count, device complexity, size, bulkiness, and/or weight if these cooling features are included.

Thus, there remains a need for an e-machine system that provides effective cooling. There remains a need for these e-machine systems, wherein the cooling features are provided in a relatively compact, low-weight package. There is also a need for such an e-machine system that also provides high manufacturing efficiency for reduced costs and manufacturing time.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

In one embodiment, an e-machine is disclosed that includes a stator core having a first axial end and a second axial end that are separated along a longitudinal axis. The stator core has a slot that extends between the first axial end and the second axial end. The e-machine further includes a plurality of winding members. The plurality of winding members comprise a plurality of longitudinal segments that are received in the slot and that extend between the first axial end and the second axial end. Individual ones of the plurality of longitudinal segments have a cross-sectional profile that is non-circular. The plurality of longitudinal segments are disposed in an abutting arrangement to define a fluid passageway within the slot and between neighboring ones of the plurality of longitudinal segments. The fluid passageway extends between the first axial end and the second axial end of the stator core.

In another embodiment, an electric motor system includes a housing that defines a motor cavity and an electric motor that is received in the motor cavity. The electric motor includes a stator core having a first axial end and a second axial end that are separated along a longitudinal axis. The stator core has a slot that extends between the first axial end and the second axial end. The electric motor includes a plurality of winding members. The plurality of winding members comprises a plurality of longitudinal segments that are received in the slot and that extend between the first axial end and the second axial end. Individual ones of the plurality of longitudinal segments have a cross-sectional profile that is non-circular. The plurality of longitudinal segments are disposed in an abutting arrangement to define a fluid passageway within the slot and between neighboring ones of the plurality of longitudinal segments. The fluid passageway extends between the first axial end and the second axial end of the stator core. The electric motor system includes a fluid coolant system configured to provide a coolant fluid into the cavity for flow along the fluid passageway between the first axial end and the second axial end.

In a further embodiment, a method of manufacturing an e-machine is disclosed. The method includes providing a stator core having a first axial end and a second axial end that are separated along a longitudinal axis. The stator core has a slot that extends between the first axial end and the second axial end. The method also includes providing a plurality of winding members, the plurality of winding members comprising a plurality of longitudinal segments. Moreover, the method includes inserting the plurality of longitudinal segments in the slot to extend between the first axial end and the second axial end. Individual ones of the plurality of longitudinal segments have a cross-sectional profile that is non-circular. Inserting the plurality of longitudinal segments includes disposing the plurality of longitudinal segments in an abutting arrangement to define a fluid passageway within the slot and between neighboring ones of the plurality of longitudinal segments. The fluid passageway extends between the first axial end and the second axial end of the stator core.

Furthermore, other desirable features and characteristics of the present disclosure will become apparent from the subsequent detailed description and the appended claims, taken in conjunction with the accompanying drawings and the preceding background.

### BRIEF DESCRIPTION OF DRAWINGS

The present disclosure will hereinafter be described in conjunction with the following drawing figures, wherein like numerals denote like elements, and wherein:

FIG. 1 is a schematic illustration of an e-machine system according to example embodiments of the present disclosure;

FIG. 2 is an isometric longitudinal section view of a stator member of the e-machine system according to example embodiments;

FIG. 3 is a detail cross-sectional view of the stator member taken along the line 3-3 of FIG. 2 according to example embodiments;

FIG. 4 is a detail cross-sectional view of the stator member of FIG. 2 according to example embodiments;

FIG. 5 is a detail cross-sectional view of the stator member of FIG. 2 according to example embodiments;

FIG. 6 is a detail cross-sectional view of the stator member of FIG. 2 according to example embodiments; and

FIG. 7 is a detail cross-sectional view of the stator member of FIG. 2 according to example embodiments.

### DETAILED DESCRIPTION

The following detailed description is merely exemplary in nature and is not intended to limit the present disclosure or the application and uses of the present disclosure. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the present disclosure and not to limit the scope of the present disclosure, which is defined by the claims. Furthermore, there is no intention to be bound by any expressed or implied theory presented in the preceding technical field, background, brief summary, or the following detailed description.

Broadly, example embodiments disclosed herein include an e-machine system, such as an electric motor system, having features that provide effective cooling for efficient operation of the e-machine.

For example, the stator member of the e-machine may include a stator core with a plurality of slots (i.e., grooves, passages, etc.) that extend between a first axial end and a second axial end of the stator core. The slots may extend along a respective longitudinal axis that may be parallel to an axis of rotation of the rotating group of the e-machine. The slots may be arranged (e.g., spaced equally) about the axis of rotation. Also, the slots may be open to the inner radial surface of the stator core.

The stator member may also include a plurality of winding members comprising a plurality of longitudinal segments that are received in respective ones of the slots. In at least one of the slots, there may be a group of the longitudinal segments. These longitudinal segments may have a provided cross-sectional shape (taken through the longitudinal axis of the slot). Also, these longitudinal segments may be disposed (i.e., layered, oriented, etc.) in an abutting arrangement. The shapes and arrangements of the winding members may provide spacing between the adjacent longitudinal segments. Thus, fluid passageways may be defined along the slots and also between neighboring ones of the longitudinal segments of the windings.

The e-machine system may also include a fluid coolant system that may provide a cooling fluid (refrigerant, coolant, oil, air, other gas, other liquid, etc.) to the e-machine. This fluid may be provided to the slots to flow amongst the longitudinal segments of the windings. Thus, cooling fluid may be provided directly to the windings and through the stator core for effective cooling.

Additionally, the e-machine may be relatively compact and lightweight. The e-machine may also provide manufacturing benefits, such as a relatively low part count, as well as case of assembly, installation, repair, and replacement.

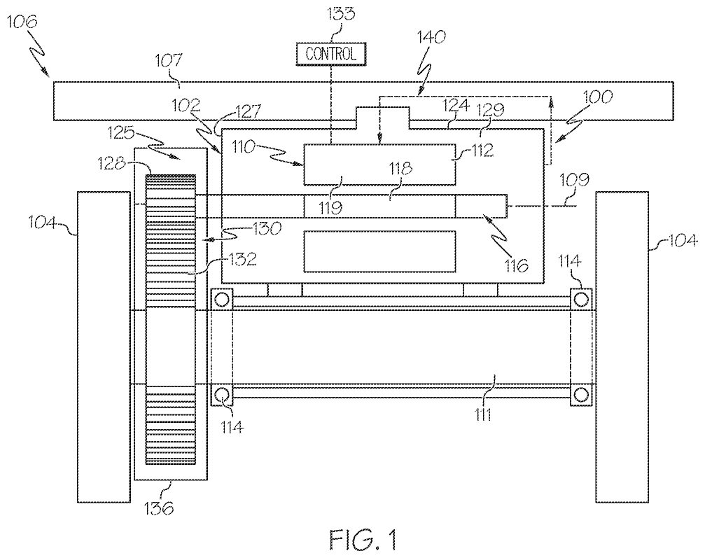

FIG. 1 is a schematic view of an e-machine system 100 according to example embodiments of the present disclosure. The e-machine system 100 may have a variety of configurations. In some embodiments, the e-machine system 100 may be configured as a traction drive system 102 that is included, for example, on a vehicle 106. Thus, the traction drive system 102 may be configured for driving one or more wheels 104 of the vehicle 106. More specifically, the wheels 104 may be included at opposite ends of an axle 111, and a chassis 107 may be supported on the wheels 104 by a suspension system (not shown). The vehicle 106 may be an electric car, truck, van, motorcycle, boat, or other vehicle. However, it will be appreciated that the e-machine system 100 may be configured otherwise without departing from the scope of the present disclosure.

Generally, the e-machine system 100 may include a housing 125. The housing 125 may include an e-machine housing 124 with a cavity 129 therein. The e-machine system 100 may also include an e-machine 110 that is received in the cavity 129 and housed within the e-machine housing 124.

The e-machine 110 may be an electric motor 112 in some embodiments. For example, in some embodiments, the electric motor 112 may be an AC three-phase electric motor. However, it will be appreciated that the e-machine 110 may be configured otherwise. The e-machine 110 may be configured as an electric generator in some embodiments. Furthermore, the e-machine 110 may be operable in some modes as a motor and in additional modes as a generator. The e-machine 110 may include a rotor member 118 and a stator member 119 that are housed within the cavity 129 of the e-machine housing 124.

The rotor member 118 may be supported on a shaft 116, and the shaft 116 may be supported for rotation about an axis 109 (i.e., rotation axis 109) within the e-machine housing 124. The stator member 119 of the e-machine 110 may be fixed within the e-machine housing 124 and may surround the rotor member 118 and the shaft 116. In embodiments in which the e-machine 110 is an electric motor 112, the shaft 116 may be referred to as an output shaft 116 of the electric motor 112. In some embodiments, a gear connection member 128 (e.g., a gear, a spline on the shaft 116, or other part with gear teeth features) may be operably supported on the shaft 116.

Also, the e-machine system 100 may include a transmission 130. The transmission 130 may generally include a geartrain 132 that is housed within a gearbox housing 136 of the housing 125. The gearbox housing 136 may be attached (e.g., fixed) to a side wall 127 of the c-machine housing 124.

The geartrain 132 may be of any suitable type. The geartrain 132 may operatively connect the e-machine 110 and the axle 111 and may transmit power therebetween. The e-machine 110 may be coupled to the wheels 104 via the transmission 130. The geartrain 132 may be attached to the gear connection member 128 and to the axle 111. The gearbox housing 136 and the e-machine housing 124 may be moveably supported on the axle 111 by one or more bearings 114 (e.g., a bearing sleeve, suspension tube, etc.) such that the axle 111 may rotate relative thereto.

During operation, the electric motor 112 may rotatably drive the shaft 116 and the gear connection member 128 supported thereon. This rotational power may transfer to the geartrain 132, which may transmit the power to the axle 111 to rotate the wheels 104 and propel the vehicle 106. These operations may be controlled by a control system 133. The control system 133 may control speed of the motor 112 and/or other functions of the motor 112.

Furthermore, the e-machine system 100 may include a fluid coolant system 140. The fluid coolant system 140 may be configured for circulating a fluid, such as a fluid coolant. The fluid may be a liquid, a coolant oil, etc.

The fluid coolant system 140 may be coupled to the stator member 119 as will be discussed. Accordingly, the fluid coolant system 140 and the stator member 119 may include features that provide cooling to the stator member 119. This may, in turn, provide cooling to the rotor member 118, to bearings, and/or to other adjacent areas of the e-machine 110.

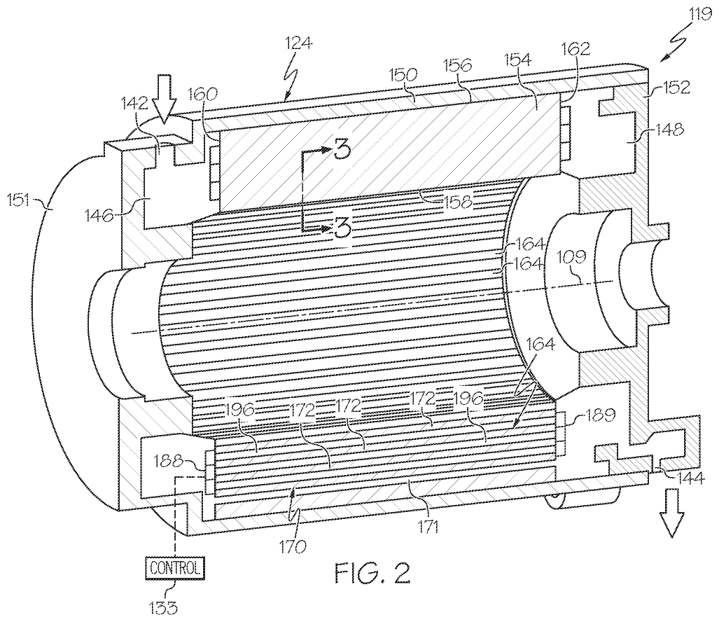

As represented in FIG. 2, the e-machine housing 124 may be cylindrical and hollow. The e-machine housing 124 may include an outer radial wall 150, a first axial wall 151, and a second axial wall 152. The outer radial wall 150 may extend in a circumferential direction about the axis of rotation 109 and may extend longitudinally between the first axial wall 151 and the second axial wall 152. The first axial wall 151 and second axial wall 152 may be disc-like and may extend transverse to the axis 109. In some embodiments, the outer radial wall 150 and first axial wall 151 may be integrally connected so as to be one-piece and unitary whereas the second axial wall 152 may be removably attached to the other end of the outer radial wall 150. The outer radial wall 150, first axial wall 151, and second axial wall 152 may collectively define the cavity 129. The cavity 129 may be substantially cylindrical and may be centered on the axis 109.

The stator member 119 may include a stator core 154. The stator core 154 may be hollow and cylindrical so as to include an outer radial surface 156, an inner radial surface 158, a first axial end 160, and a second axial end 162. The stator core 154 may comprise a plurality of disc-like laminations that are stacked together and arranged along the axis 109 to collectively define the outer radial surface 156 and the inner radial surface 158.

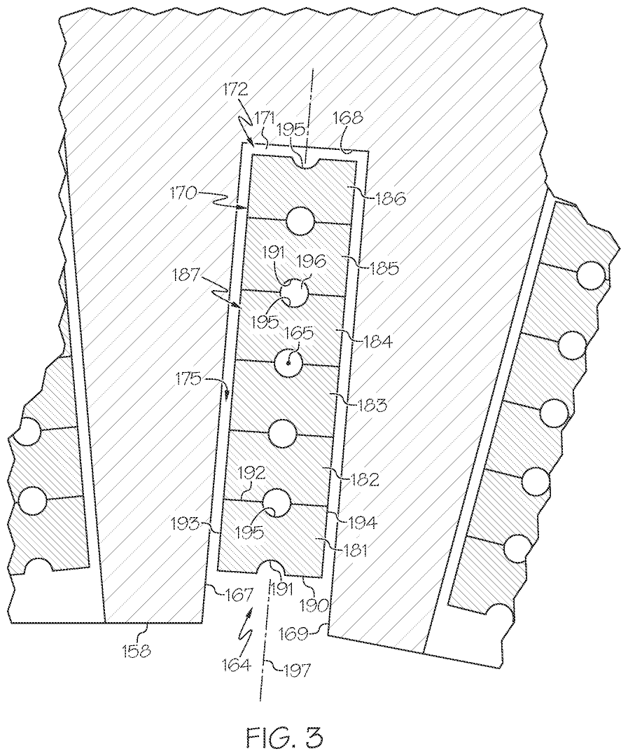

As shown in FIGS. 2 and 3, the stator core 154 may include a plurality of slots 164 (i.e., grooves, passages, etc.). It will be appreciated that the laminations of the stator core 154 may individually include notches that, when stacked together, collectively define the slots 164. One of the slots 164 is shown in detail in FIG. 3 and may be representative of the others. As shown, the slot 164 may be somewhat rectangular. Also, in some embodiments, the slot 164 may be open at the inner radial surface 158. The slot 164 may be defined by two radially-extending inner slot surfaces 167, 169 and a recessed radial inner slot surface 168. The slot 164 may extend along a longitudinal axis 165 between the first axial end 160 and the second axial end 162 of the stator core 154. The longitudinal axis 165 may be substantially parallel to the axis of rotation 109. The slot 164 may be open at the first axial end 160 and the second axial end 162 of the stator core 154. The plurality of slots 164 may be disposed in spaced arrangement (e.g., equally spaced) about the axis of rotation 109.

The stator member 119 may further include a plurality of windings 170 (i.e., winding members, wiring members, etc.). The windings 170 may be electrically conductive and may comprise a plurality of elongate segments. The windings 170 may be arranged in a plurality of coils that wrap back-and-forth between first and second axial ends 160, 162 of the stator core 154 and between different ones of the slots 164.

Accordingly, the windings 170 may include a plurality of longitudinal segments 172 that are received in the slots 164 of the stator core 154 and that extend generally along the axis 165 of the respective slot 164. As shown in FIG. 3, the longitudinal segments 172 may include a first longitudinal segment 181, a second longitudinal segment 182, a third longitudinal segment 183, a fourth longitudinal segment 184, a fifth longitudinal segment 185, and a sixth longitudinal segment 186 in one of the slots 164. It will be appreciated that there may be any number of longitudinal segments 172 in the slots 164.

As shown in FIG. 2, the windings 170 may also include a plurality of first end members 188 proximate the first axial end 160 of the stator core 154 and a plurality of second end members 189 proximate the second axial end 162. The first end members 188 may connect respective pairs of longitudinal segments 172 in different slots 164, and the first end members 188 may be disposed outside the stator core 154 on the first axial end 160. In some embodiments, at least one of the first end members 188 may extend away from the first axial end 160 to electrically connect to the control system 133. Furthermore, the second end members 189 may connect respective pairs of the longitudinal segments 172 in different slots 164. The second end members 189 may be disposed outside the stator core 154 at the second axial end 162. The first and second end members 188, 189 may electrically connect ones of the longitudinal segments 172 in a known manner for operation of the stator member 119 and for operative connection to the control system 133.

FIG. 3 shows example cross-sectional profiles of the longitudinal segments 172 (taken normal to the axis 165 of the slot 164 and normal to the axis of rotation 109 of the motor 112). FIG. 3 also shows an example arrangement 187 of the longitudinal segments 172 within the slot 164.

As shown, the longitudinal segments 181-186 may have substantially similar cross-sectional profiles to each other. The longitudinal segments 181-186 may be four-sided to have a substantially rectangular cross-sectional profile. At least one side of the longitudinal segments 181-186 may be substantially flat. For example, the first longitudinal segment 181 may include an inner radial side 190, an outer radial side 192, a first tangential side 193, and a second tangential side 194. The inner radial side 190 may face inward radially toward the axis 109, and the inner radial side 190 may include a recessed inner groove 191 that extends along the axis 165 along the majority (e.g., an entirety) of the first longitudinal segment 181. The outer radial side 192 may face outward radially from the axis 109 and may similarly include an outer groove 195. The inner groove 191 and/or the outer groove 195 may be semi-circular in the cross-section. The first and second tangential sides 193, 194 may be substantially flat. The inner and outer grooves 191, 195 may be substantially aligned along a radial axis 197 that intersects the axis 109. Accordingly, the cross-sectional profile of the first longitudinal segment 181 may be somewhat H-shaped.

The longitudinal segments 172 may be formed, shaped, and provided with the cross-sectional profile of FIG. 3 in a number of ways without departing from the scope of the present disclosure. For example, wire may be extruded or drawn through a die to shape the cross sectional profile of the longitudinal segments 172. Once shaped, the plurality of windings 170 may be provided on the stator core 154.

As shown in FIG. 3, the longitudinal segments 181-186 may be arranged within the slots 164 in a layered or radially-stacked arrangement 187. The longitudinal segments 181-186 may abut each other in the arrangement 187. The longitudinal segments 181-186 may be aligned along the radial axis 197. The first longitudinal segment 181 may be disposed at a radially inward position, closest to the inner radial surface 158 of the stator core 154. The second longitudinal segment 182 may be layered, stacked, or otherwise abutted against the outer radial side 192 to be disposed radially outboard from the first longitudinal segment 181. The third longitudinal segment 183 may be similarly abutted against the second longitudinal segment 182 to be disposed radially outboard therefrom. The fourth longitudinal segment 184 may be abutted against the third longitudinal segment 183 to be disposed radially outboard therefrom. The fifth longitudinal segment 185 may be abutted against the fourth longitudinal segment 184 to be disposed radially outboard therefrom. The sixth longitudinal segment 186 may be abutted against the fifth longitudinal segment 185 to be disposed radially outboard therefrom.

The cross-sectional profiles of the longitudinal segments 172 may have integrally-included features that define fluid passages between neighboring pairs of the segments 172. In the embodiments represented in FIG. 3, for example, the inner and outer grooves 191, 195 define such passages. More specifically, the inner grooves 191 of one longitudinal segments 172 may align with the opposing outer groove 195 of another longitudinal segment 172. Accordingly, opposing pairs of the inner and outer grooves 191, 195 may cooperate to define a respective internal passages 196. For example, the inner groove 191 of the fifth longitudinal segment 185 and the outer groove 195 of the fourth longitudinal segment 184 may cooperatively define the internal passage 196 indicated in FIG. 3. This internal passage 196 may extend along the axis 165 and substantially parallel to the axis of rotation 109. The internal passage 196 may be continuous and uninterrupted from the first axial end 160 to the second axial end 162 of the stator core 154. The internal passages 196 between the other longitudinal segments 172 may be substantially similar, but disposed at different radial positions between others of the longitudinal segments 172.

Moreover, the arrangement 187 of the longitudinal segments 172 may be supported within the slots 164 and substantially centered therein. The slot 164 may be shaped correspondingly to the arrangement 187 of longitudinal segments 172. As such, there may be a substantially uniform gap 175 between the longitudinal segments 172 and the inner slot surfaces 167, 168, 169 of the slot 164. The gap 175 may also be open and continuous in the longitudinal direction between the first axial end 160 and the second axial end 162 of the stator core 154. Thus, the gap 175 may define at least one additional fluid passageway 171 longitudinally through the stator core 154, over the arrangement 187 of longitudinal segments 172. As shown in FIG. 3, the additional fluid passageway 171 may be defined between the radially-extending inner slot surface 167 and the first tangential sides 193 of the longitudinal segments 172, between the outer radial side 192 and the radial inner slot surface 168, and between the inner slot surface 169 and the second tangential sides 194 of the longitudinal segments 172 so as to surround the arrangement 187. The outer groove 195 of the sixth longitudinal segment 186 may oppose the radial inner slot surface 168 to provide additional cross-sectional area for the passageway 171.

The fluid coolant system 140 may be fluidly connected to the internal passages 196 and the passageways 171 of the stator member 119 to provide fluid coolant thereto. As shown in FIG. 2, the e-machine housing 124 may include a coolant inlet 142 and a coolant outlet 144. The coolant inlet 142 and the coolant outlet 144 may be spaced apart along the axis 109. The coolant inlet 142 may extend radially into the first axial wall 151. The coolant outlet 144 may extend radially out of the second axial wall 152. The coolant inlet 142 and the coolant outlet 144 may be disposed on opposite sides of the axis 109.

The inlet 142 may extend into the first axial wall 151 and may fluidly connect to an annular first cavity 146 that extends about the axis 109 and about the first axial end 160 of the stator core 154. The second axial wall 152 may include a similar annular second cavity 148 that extends about the second axial end 162 of the stator core 154. The outlet 144 may be fluidly connected to the second cavity 148.

The first cavity 146 and the second cavity 148 may be fluidly connected to the slots 164 and, thus, to the internal passages 196 and fluid passageways 171. Accordingly, during operation, fluid supplied by the inlet 142 may flow into the first cavity 146 and flow around, between, and amongst the longitudinal segments 172. This fluid may also flow between the arrangement 187 and the inner slot surfaces 167, 168, 169 of the stator core 154. This fluid may receive heat as it flows longitudinally through the slots 164 and may flow into the second cavity 148 before exiting via the outlet 144.

Accordingly, fluid coolant may flow directly over, between, and amongst the arrangement 187 of longitudinal segments 172 as the coolant flows longitudinally along the stator member 119. Accordingly, the fluid coolant system 140 may effectively cool the motor 112. Furthermore, the e-machine system 100 may be compact and lightweight. Also, the part count may be relatively low, and the e-machine system 100 may be manufactured with high efficiency.

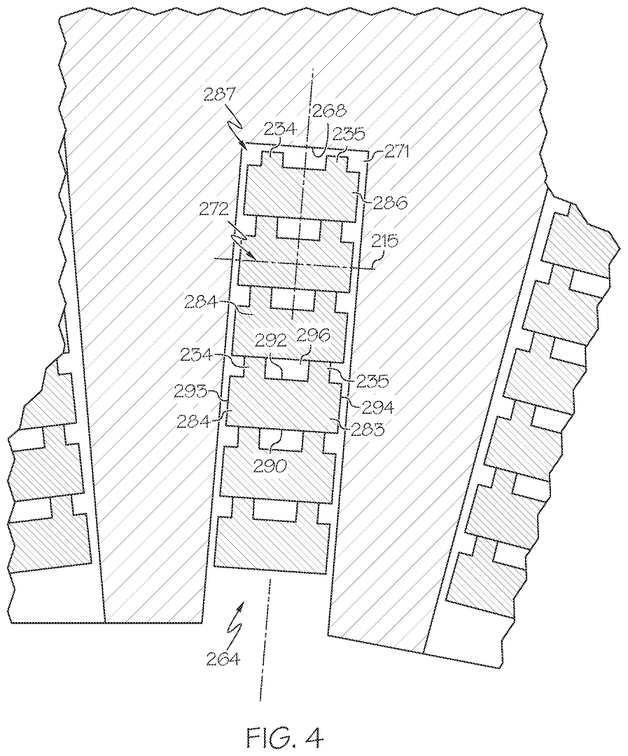

Referring now to FIG. 4, additional embodiments of the arrangement 287 of the longitudinal segments 272 within the slots 264 will be discussed. Features that correspond to the embodiments of FIG. 3 are indicated with corresponding reference numbers increased by 100.

As shown, the longitudinal segments 272 may each be substantially four-sided with the inner radial side 290, the first tangential side 293, and the second tangential side 294 being substantially flat in the cross-sectional profile. As least one of the longitudinal segments 272 may include at least one projection, such as a first rib 234 and a second rib 235 that project from the outer radial side 292. The first and second ribs 234, 235 may be rectangular and may project outward radially from the axis of rotation. Accordingly, the cross-sectional profiles of the longitudinal segments 272 may be symmetrical with respect to the radial axis 297 and may be asymmetrical with respect to a tangential line 215 that is normal to the radial axis 297. In the arrangement 287, the first and second ribs 234, 235 of one of the longitudinal segments 272 may abut against the inner radial side 290 of a neighboring longitudinal segment 272. For example, the ribs 234, 235 of the third longitudinal segment 283 may abut against the inner radial side 290 of the fourth longitudinal segment 284. As a result, the integrally-attached ribs 234, 235 may space the inner radial side 290 of the fourth longitudinal segment 284 away (in a radially-outboard direction) from the third longitudinal segment 283. Thus, the internal passage 296 may be defined in the space between the outer radial side 292 of the third longitudinal segment 283 and the inner radial side 290 of the fourth longitudinal segment 284. Furthermore, the ribs 234, 235 of the sixth longitudinal segment 286 may project toward the radial inner slot surface 268 such that the additional passageway 271 is partly defined thereby. Other features of the embodiments of FIG. 4 may be substantially similar to those of FIG. 3 and the description of those features will not be repeated.

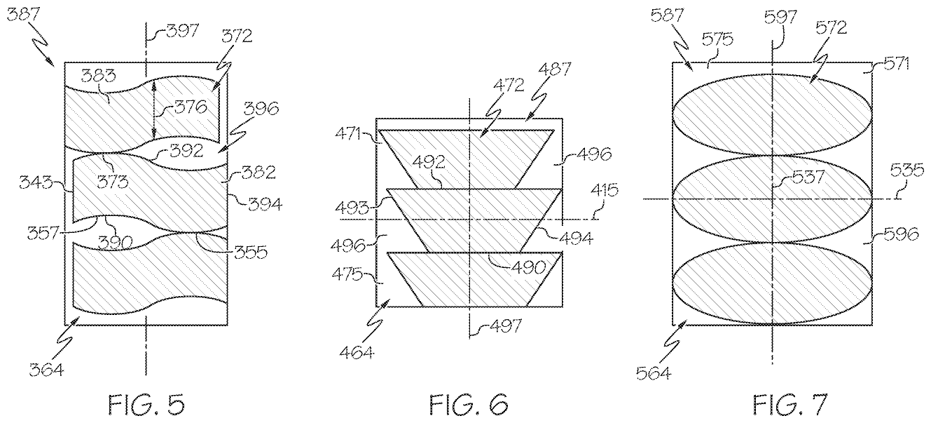

Referring now to FIG. 5, additional embodiments of the arrangement 387 of the longitudinal segments 372 within the slots 364 will be discussed. Features that correspond to the embodiments of FIG. 3 are indicated with corresponding reference numbers increased by 200.

As shown, the longitudinal segments 372 may have a wave-shaped or other contoured cross-sectional profile. These segments 372 may be asymmetrical with respect to the radial axis 397. For example, the longitudinal segments 372 may be substantially four-sided with the first tangential side 393, and the second tangential side 394 being substantially flat in the cross-sectional profile. Also, the inner radial side 390 and the outer radial side 392 may be similarly contoured and wavy with respect to a plane that is normal to the axis 397. As such, the inner and outer radial sides 390, 392 may include both three-dimensional convex curvature 355 and concave curvature 357 relative to the radial axis 397. In some embodiments, a thickness 376 (measured between the inner and outer radial sides 390, 392) may be substantially constant. Furthermore, when arranged and stacked along the radial axis 397 in the arrangement 387, the direction of contour of one longitudinal segment 372 (relative to the radial axis 397) may be opposite to the neighboring longitudinal segment 372. Stated differently, the longitudinal segment 372 may be rotated (e.g., 180 degrees) about the axis 397 relative to the longitudinal segment(s) 372 that are immediately adjacent in the stacked arrangement 387. Thus, the second longitudinal segment 382 may include the convex curvature 355 on the outer radial side 392 that is radially aligned with the convex curvature 355 on the inner radial side 390 of the third longitudinal segment 383 to define an abutment area 373 therebetween. Also, the second longitudinal segment 382 may include the concave curvature 357 on the outer radial side 392 that is radially aligned with the concave curvature 357 on the inner radial side 390 of the third longitudinal segment 383. Accordingly, the aligned concave curvatures 357 may define respective ones of the internal passages 396. The additional passageway 371 may also be partly defined by the waviness and contour of the longitudinal segments 372.

Referring now to FIG. 6, additional embodiments of the arrangement 487 of the longitudinal segments 472 within the slots 464 will be discussed. Features that correspond to the embodiments of FIG. 3 are indicated with corresponding reference numbers increased by 300.

As shown, the longitudinal segments 472 may each be substantially four-sided with the inner radial side 490, the outer radial side 492, the first tangential side 493, and the second tangential side 494 being substantially flat in the cross-sectional profile. The inner radial side 490 and the outer radial side 492 may be substantially parallel and may be normal to the radial axis 497. The first and second tangential sides 493, 494 may be non-parallel. Accordingly, the cross-sectional profile may be trapezoidal in shape. The cross-sectional profile may also be asymmetrical with respect to the tangential line 415. The internal passages 496 between neighboring longitudinal segments 472 may be defined, for example, between the angled first tangential side 493 and the neighboring outer radial surface 492. Similarly, internal passages 496 may be defined between the angled second tangential side 494 and the neighboring outer radial surface 492. The gap 475 between the arrangement 487 and the slot 464 may also be defined by the angled first and second tangential sides 493, 494 to thereby define the additional fluid passageway 471.

Referring now to FIG. 7, additional embodiments of the arrangement 587 of the longitudinal segments 572 within the slots 564 will be discussed. Features that correspond to the embodiments of FIG. 3 are indicated with corresponding reference numbers increased by 400.

As shown, the longitudinal segments 572 may each have an ovate cross-sectional profile. The longitudinal segments 572 may have a major axis 535 and a minor axis 537. The major axis 535 may be greater than the minor axis 537. The minor axes 537 of the longitudinal segments 572 may be aligned along the radial axis 597 of the slot 564, and the major axes 535 may be transverse thereto. Thus, the internal passages 596 between neighboring longitudinal segments 572 may be defined, for example, between the ovate longitudinal segments 572. The gap 575 between the arrangement 587 and the slot 564 may also be defined by the ovate cross-sectional profile of the longitudinal segments 572 to thereby define the additional fluid passageway 571.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the present disclosure as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

As used herein, the term “axial” refers to a direction that is generally parallel to or coincident with an axis of rotation, axis of symmetry, or centerline of a component or components. For example, in a cylinder or disc with a centerline and generally circular ends or opposing faces, the “axial” direction may refer to the direction that generally extends in parallel to the centerline between the opposite ends or faces. In certain instances, the term “axial” may be utilized with respect to components that are not cylindrical (or otherwise radially symmetric). For example, the “axial” direction for a rectangular housing containing a rotating shaft may be viewed as a direction that is generally parallel to or coincident with the rotational axis of the shaft. Furthermore, the term “radially” as used herein may refer to a direction or a relationship of components with respect to a line extending outward from a shared centerline, axis, or similar reference, for example in a plane of a cylinder or disc that is perpendicular to the centerline or axis. In certain instances, components may be viewed as “radially” aligned even though one or both of the components may not be cylindrical (or otherwise radially symmetric). Furthermore, the terms “axial” and “radial” (and any derivatives) may encompass directional relationships that are other than precisely aligned with (e.g., oblique to) the true axial and radial dimensions, provided the relationship is predominantly in the respective nominal axial or radial direction. As used herein, the term “substantially” denotes within 5% to account for manufacturing tolerances. Also, as used herein, the term “about” denotes within 5% to account for manufacturing tolerances.

While at least one exemplary embodiment has been presented in the foregoing detailed description of the present disclosure, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment of the present disclosure. It being understood that various changes may be made in the function and arrangement of elements described in an exemplary embodiment without departing from the scope of the present disclosure as set forth in the appended claims.

What is claimed is:

1. An e-machine comprising:
a stator core having a first axial end and a second axial end that are separated along a longitudinal axis, the stator core having a slot that extends between the first axial end and the second axial end;
a plurality of winding members, the plurality of winding members comprising a plurality of longitudinal segments that are received in the slot and that extend between the first axial end and the second axial end, individual ones of the plurality of longitudinal segments having a cross-sectional profile that is non-circular, the plurality of longitudinal segments disposed in an abutting arrangement to define a fluid passageway within the slot and between neighboring ones of the plurality of longitudinal segments, the fluid passageway extending between the first axial end and the second axial end of the stator core.

2. The e-machine of claim 1, wherein the neighboring ones includes a first one of the plurality of longitudinal segments and a second one of the plurality of longitudinal segments, the first one including a first groove, and wherein the first one of the plurality of longitudinal segments abuts against the second one of the plurality of longitudinal segments in the abutting arrangement;
the first groove and the second one of the plurality of longitudinal segments cooperating to define the fluid passageway.

3. The e-machine of claim 2, wherein the second one of the plurality of longitudinal segments includes a second groove; and
the first groove and the second groove cooperating to define the fluid passageway.

4. The e-machine of claim 1, wherein the neighboring ones includes a first one of the plurality of longitudinal segments and a second one of the plurality of longitudinal segments, the first one including a first side with a projection that projects from the first side, and the projection abuts against the second one of the plurality of longitudinal segments in the abutting arrangement;
the first side and the second one of the plurality of longitudinal segments cooperating to define the fluid passageway.

5. The e-machine of claim 4, wherein the second one of the plurality of longitudinal segments includes a second side that is flat;
wherein the projection abuts against the second side; and
wherein the first side and the second side cooperate to define the fluid passageway.

6. The e-machine of claim 1, wherein the neighboring ones includes a first one of the plurality of longitudinal segments and a second one of the plurality of longitudinal segments, the first one including a wavy cross-sectional profile with a concave contour and a convex contour, the convex contour abutting against a second one of the plurality of longitudinal segments in the abutting arrangement;
the concave contour and the second one of the plurality of longitudinal segments cooperating to define the fluid passageway.

7. The e-machine of claim 6, wherein the first one and the second one of the plurality of longitudinal segments are stacked along a radial axis;
wherein the second one of the plurality of longitudinal segments includes the wavy cross-sectional profile with an opposite concave contour and an opposite convex contour, the concave contour and the opposite concave contour being contoured opposite each other along the radial axis, the convex contour and the opposite convex contour being contoured opposite each other along the radial axis;
wherein the convex contour of the first one abuts the opposite convex contour of the second one; and
wherein the concave contour of the first one is aligned along the radial axis with the opposite concave contour of the second one to cooperatively define the fluid passageway.

8. The e-machine of claim 6, wherein the cross-sectional profile has at least one contoured side and at least one flat side.

9. The e-machine of claim 1, wherein the cross-sectional profile is trapezoidal.

10. The e-machine of claim 1, wherein the cross-sectional profile is ovate.

11. The e-machine of claim 1, wherein the slot is defined by an inner slot surface of the stator core;
wherein the plurality of longitudinal segments is disposed in the abutting arrangement within the slot to define another fluid passageway between the inner slot surface and the plurality of longitudinal segments, the other fluid passageway extending substantially along the longitudinal axis.

12. The e-machine of claim 1, further comprising an e-machine housing that defines a cavity, the stator core received in the cavity, the e-machine housing having a fluid inlet and a fluid outlet, the fluid inlet and the fluid outlet being spaced apart along the longitudinal axis, and the fluid inlet and the fluid outlet being in fluid communication with the fluid passageway.

13. The e-machine of claim 1, wherein the cross-sectional profile is asymmetrical.

14. An electric motor system comprising:
a housing that defines a motor cavity;
an electric motor that is received in the motor cavity, the electric motor including a stator core having a first axial end and a second axial end that are separated along a longitudinal axis, the stator core having a slot that extends between the first axial end and the second axial end, the electric motor including a plurality of winding members, the plurality of winding members comprising a plurality of longitudinal segments that are received in the slot and that extend between the first axial end and the second axial end, individual ones of the plurality of longitudinal segments having a cross-sectional profile that is non-circular, the plurality of longitudinal segments disposed in an abutting arrangement to define a fluid passageway within the slot and between neighboring ones of the plurality of longitudinal segments, the fluid passageway extending between the first axial end and the second axial end of the stator core; and
a fluid coolant system configured to provide a coolant fluid into the cavity for flow along the fluid passageway between the first axial end and the second axial end.

15. The electric motor system of claim 14, wherein the housing has a fluid inlet and a fluid outlet, the fluid inlet and the fluid outlet being spaced apart along the longitudinal axis, and the fluid inlet and the fluid outlet being in fluid communication with the fluid passageway.

16. The electric motor system of claim 14, wherein the slot is defined by an inner slot surface of the stator core;
wherein the plurality of longitudinal segments is disposed in the abutting arrangement within the slot to define another fluid passageway between the inner slot surface and the plurality of longitudinal segments, the other fluid passageway extending substantially along the longitudinal axis.

17. The electric motor system of claim 14, wherein the neighboring ones includes a first one of the plurality of longitudinal segments and a second one of the plurality of longitudinal segments, the first one including a first groove, and wherein the first one of the plurality of longitudinal segments abuts against the second one of the plurality of longitudinal segments in the abutting arrangement;
the first groove and the second one of the plurality of longitudinal segments cooperating to define the fluid passageway.

18. The electric motor system of claim 14, wherein the neighboring ones includes a first one of the plurality of longitudinal segments and a second one of the plurality of longitudinal segments, the first one including a first side with a projection that projects from the first side, and the projection abuts against the second one of the plurality of longitudinal segments in the abutting arrangement;
the first side and the second one of the plurality of longitudinal segments cooperating to define the fluid passageway.

19. The electric motor system of claim 14, wherein the neighboring ones includes a first one of the plurality of longitudinal segments and a second one of the plurality of longitudinal segments, the first one including a first side with one of a projection that projects from the first side and a groove that is included in the first side;
the first side and the second one of the plurality of longitudinal segments cooperating to define the fluid passageway.

20. A method of manufacturing an e-machine comprising:
providing a stator core having a first axial end and a second axial end that are separated along a longitudinal axis, the stator core having a slot that extends between the first axial end and the second axial end;
providing a plurality of winding members, the plurality of winding members comprising a plurality of longitudinal segments; and
inserting the plurality of longitudinal segments in the slot to extend between the first axial end and the second axial end, individual ones of the plurality of longitudinal segments having a cross-sectional profile that is non-circular, including disposing the plurality of longitudinal segments in an abutting arrangement to define a fluid passageway within the slot and between neighboring ones of the plurality of longitudinal segments, the fluid passageway extending between the first axial end and the second axial end of the stator core.
